(19) United States
(12) Patent Application Publication
(10) Pub. No.: US 2003/0090074 A1
(43) Pub. Date: May 15, 2003

(54) Steering and handling device for moving roll cages

(76) Inventors: Matthew Joseph Smith, Brailsford (GB); Steve Mather, Hilton (GB)

Correspondence Address: GARY L. HUUSKO, 15 SOUTH FIFTH STREET, SUITE 1200, MINNEAPOLIS, MN, 55402-1063, US

(21) Appl. No.: 10/010,874

(22) Filed: Nov. 9, 2001

(51) Int. Cl. B62B 11/00

(52) U.S. Cl. 280/47.34

(57) ABSTRACT

A steering and handling device (1) for moving a roll cage (100) which has a generally U-shaped base frame (102) with castor wheels (106) at its forward end and fixed wheels at its rearward end (110). The device (1) includes a body (2) defining a steering axis and having channel means (36) extending in cantilever rearwardly of the steering axis. The channel means (36) is for releasably engaging the base frame (102) of the roll cage (100) between the front castor wheels (106). A steering tiller (4) is pivotally mounted on the body (2) and extends forwardly and upwardly from the body (2) and terminates in a handle portion (10). An axle (6) is fast to the steering tiller (4) beneath the body (2) on which wheels (8) are mounted.

### BACKGROUND OF INVENTION

The invention relates to steering and handling devices for moving A-frame roll cages. Roll cages are generally used for transporting goods over level surfaces, for example from the warehousing sections to the retailing sections of supermarkets. There are two distinct designs of roll cages, known in the trade as A-frame and Z-frame cages. The distinction between the two lies in the shape, in plan view, of the base frame. So-called Z-frame roll cages have a base frame which is N-shaped, and the roll cages can be nested together by interleaving the base frames of adjacent roll cages slightly in echelon, with the superstructure of successive roll cages folding and nesting together in known manner. So-called A-frame roll cages have a generally U-shaped base frame, optionally with a reinforcing bar connecting together opposite branches of the U near to the forward end of the roll cage. As with the Z-frame roll cages, cages can be nested together when not in use with a partial collapse of some parts of the superstructure of the roll cage.

This invention relates to a steering and handling device exclusively for so-called A-frame roll cages, which have generally U-shaped base frames. Typically the base frames are made from 50 mm×25 mm box section, with castor wheels at the forward end and fixed wheels at the rearward end. The industry standard is that the wheels raise the base frame approximately 160 mm from the floor.

When the roll cages are moved around a supermarket, they are designed to be pushed from the open rear end of the superstructure. That provides a stable movement, but there is a problem in that a fully loaded roll cage can obscure the view ahead of the person pushing and steering the cage, so that there is a danger that the roll cage can be steered inadvertently into fixed objects or even members of the public in the supermarkets. Some personnel prefer to pull the roll cages, but to do that the superstructure is generally grasped at a relatively high level, which can cause instability of the moving roll cage particularly when it is not weighed down with merchandise.

It is an object of the invention to provide a steering and handling device for increasing the ease with which shop assistants or warehousing personnel can safely manoeuvre A-frame roll cages in a potentially crowded environment.

### BRIEF SUMMARY OF INVENTION

The invention provides a steering and handling device for moving a roll cage which has a generally U-shaped base frame with castor wheels at its forward end and wheels at its rearward end, the device comprising a body defining a steering axis and having channel means extending in cantilever rearwardly of the steering axis for releasably engaging the base frame of the roll cage between the castor wheels; and a steering member pivotally mounted on the body and comprising a steering tiller pivotable about the steering axis, extending forwardly and upwardly from the body and terminating in a handle portion, and wheel means rotatably mounted on an axle mounted on the steering tiller beneath the body.

It is important that the device of the invention should be capable of steering and handling existing roll cages without modification to the roll cage itself The device of the invention achieves that because the channel means on the body is designed to releasably engage the base frame of the roll cage between the castor wheels, being a portion of 50 mm×25 mm box section which is standard between roll cages of different manufacture. Furthermore, because the channel means engages the roll cage at a low point, the roll cages can be moved safely whether full or empty, without any risk of causing them to overbalance as happens when the user tries to steer the roll cage by engaging the superstructure portion.

The cantilever arrangement of the channel means on the body makes it possible to bring the device of the invention into engagement with a roll cage easily and reliably. The steering tiller is raised, causing the body to swivel around the axle and the channel means to lower by virtue of its cantilever mounting. The channel means can then be passed beneath the portion of the base frame of the roll cage which extends between the castor wheels, and then simple lowering of the steering tiller is sufficient to raise the channel means to bring it into releasable engagement with the base frame.

The channel means preferably comprises an inclined forward face, a bottom face and a rearward face for surrounding three sides of the base frame of the roll cage, and a retention lip extending forwardly of the top edge of the rearward face to lap over the top of the base frame of the roll cage to engage the base frame when the steering axis of the device is in a substantially vertical orientation. A resilient connection between the body and the steering member greatly assists the engagement and disengagement of the channel means with the base frame of the roll cage. To that end a resilient member is preferably positioned between the axial and the body so as to bias the body away from the axial. That resilient member is preferably a coil spring around the steering tiller below the body, in compression between the axle and the body.

The axle is mounted on the steering tiller, so that pivotal movement of the tiller about the steering axis causes the wheel means mounted on the axle to follow the pivotal movement of the tiller. It is highly desirable for the tiller to have a releasable lock means for locking it in the straight-ahead position relative to the body when the roll cage is parked or when the steering and handling device is disengaged from the roll cage. That releasable lock means can be incorporated into the design by making use of the resilient member biasing the body away from the axle. Preferably the axle mounts two wheels, which should be spaced sufficiently closely together that they do not foul the roll cage when steering the cage. Also the length of the channel means and the size and spacing of the wheel means mounted on the axle should be such that a full 360° turning circle is permitted of the castor wheels at the forward end of the roll cage, without fouling the steering and handling device.

### BRIEF DESCRIPTION OF DRAWINGS

FIG. 1 is an upper perspective view of a steering and handling device in accordance with the present invention;

FIG. 2 is a lower perspective view of the steering and handling device of FIG. 1;

FIG. 3 is a front detail of the steering and handling device of FIG. 1;

FIG. 4 is side detail of the steering and handling device of FIG. 1;

FIG. 5 is a plan view of the steering and handling device of FIG. 1 releasably engaged with the U-shaped base frame of a roll cage;

FIG. 6 is a side view showing how the steering and handling device of FIG. 1 is releasably engaged with the U-shaped base frame of a roll cage at a first instance in time;

FIG. 7 is a side view showing how the steering and handling device of FIG. 1 is releasably engaged with the U-shaped base frame of a roll cage at a second instance in time; and

FIG. 8 is a side view showing how the steering and handling device of FIG. 1 is releasably engaged with the U-shaped base frame of a roll cage at a third instance in time.

### DETAILED DESCRIPTION OF INVENTION

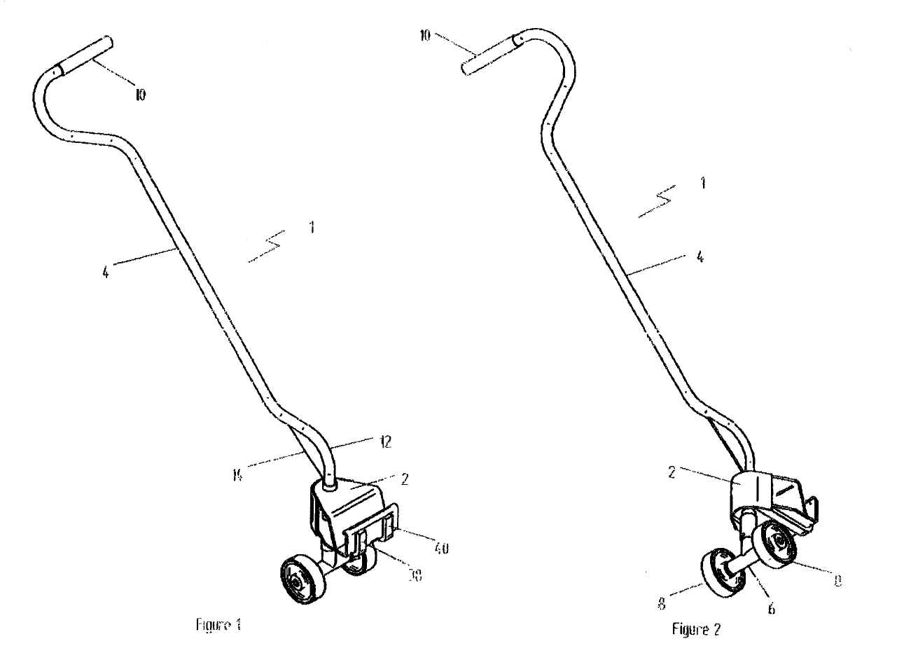

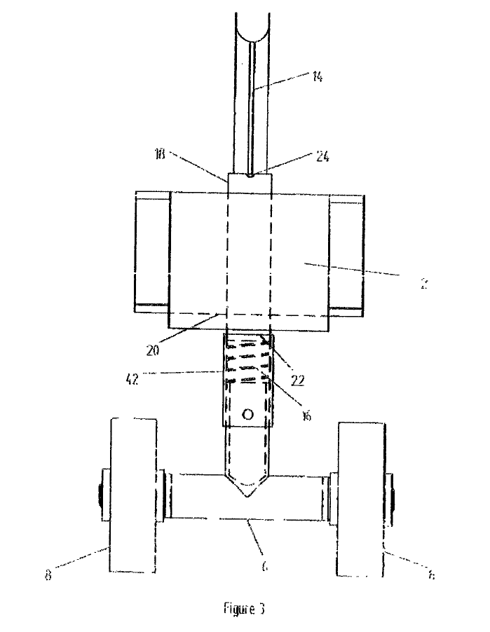

A steering and handling device (hereinafter refereed to as the “device”) according to the present invention will be described with reference to FIGS. 1 to 4. The device 1 includes a body 2 and a steering tiller 4. The lower end of the steering tiller 4 passes through a pair of holes in the body 2 so that it is pivotally mounted. An axle 6 is fast to the lower end of the steering tiller 4 beneath the body 2 and a steering wheel 8 is rotatably mounted at each end of the axle 6. Pivotal movement of the steering tiller 4 therefore causes the steering wheels 8 to turn so that the device 1 can be steered about a steering axis. The upper end of the steering tiller 4 terminates in a handle portion 10 and the lower end of the steering tiller 4 is joined to the upper end by means of a swan-necked portion 12 that is reinforced by a web 14. In use the lower end of the steering tiller 4 is vertical so that the steering axis is vertical, and the upper end extends forwardly and upwardly from the body 2 so that the handle portion 10 can be grasped by the shop assistant or warehousing personnel.

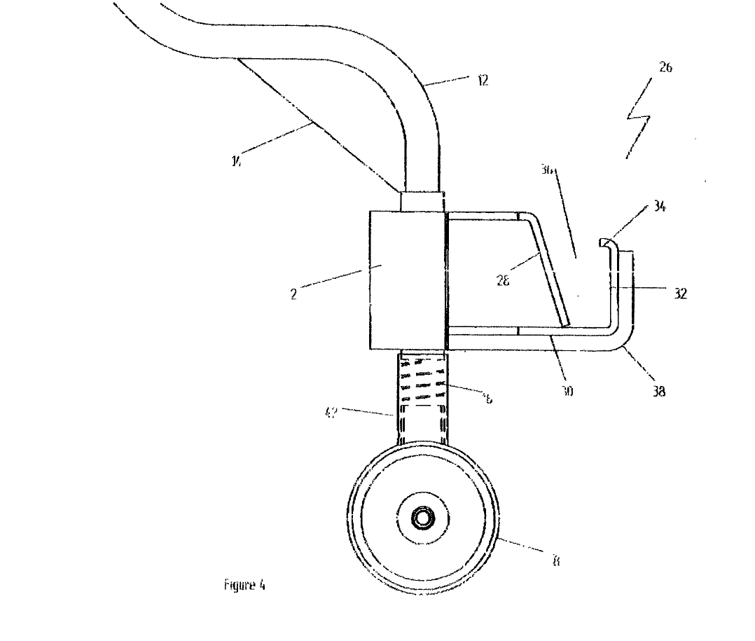

The body 2 is free to move axially along the lower end of the steering tiller 4 but is biased away from the axle 6 by a coil spring 16 (FIG. 3). The body 2 includes an upper collar 18 that is biased into contact with the web 14 to provide an upper limit to the axial movement of the body. A lower limit to the axial movement of the body 2 is provided by the underside of the body 2 which contacts an upper face 22 forming the upper end of a sleeve 42 around the steering tiller 4 when the coil spring 16 is compressed. The body 2 has an axial travel of about 15 mm between the upper and lower limits.

When the device 1 is not in use the web 14 can engage with a V-shaped recess 24 provided in the upper collar 20 to lock the steering tiller 4 and the steering wheels 8 in the straight-ahead position relative to the body 2.

The body 2 includes an engaging structure 26 (see FIG. 4) extending in cantilever rearwardly of the lower end of the steering tiller 4. The engaging structure 26 has an inclined forward face 28, a bottom face 30 and a rearward face 32. A retention lip 34 extends forwardly from a top edge of the rearward face 32. The three faces together create a channel 36 for receiving the base frame of a roll cage as described in more detail below. A pair of L-shaped reinforcing beams 38, 40 surround the bottom face 30 and the rearward face 32 to provide additional strength.

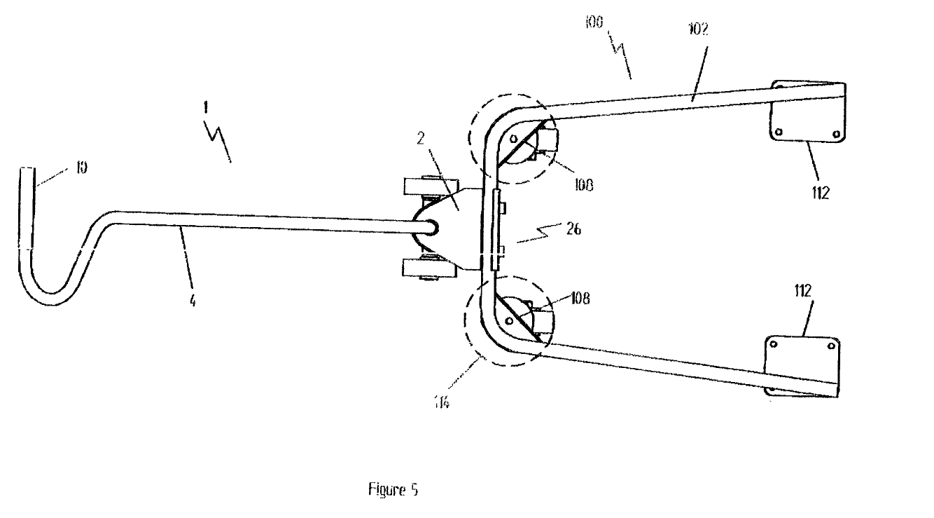

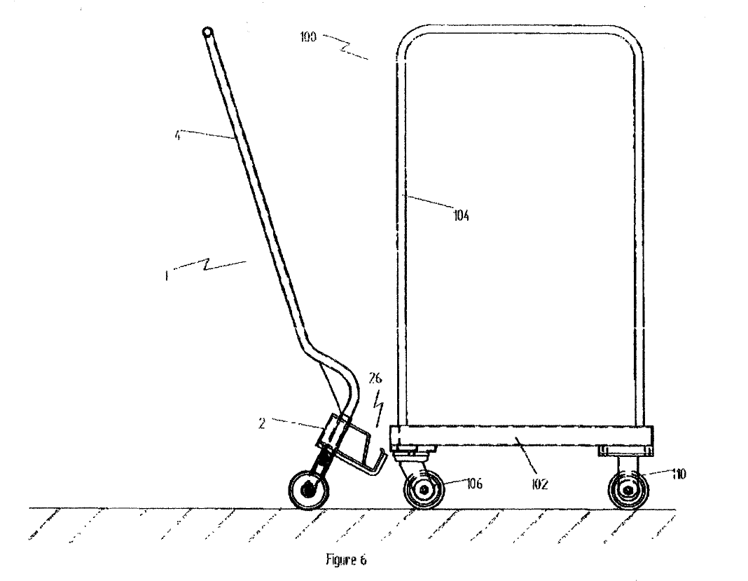

An A-frame roll cage (hereinafter referred to as the “roll cage”) will be described with reference to FIGS. 5 to 8. The roll cage 100 includes a U-shaped base frame 102 and a superstructure 104. A pair of castor wheels 106 are provided on mounting brackets 108 at the forward end of the roll cage 100 and a pair of fixed wheels 110 are provided on mounting brackets 112 at the rearward end of the roll cage. The wheels 106, 110 of the roll cage 100 raise the base frame 160 mm above the floor. However, any slight deviation in this figure can be accommodated by the axial travel of the body 2. The base frame 102 is made from 50 mm×25 mm box section and the dimensions of the engaging structure 26 are chosen so that the base frame is tightly received within the channel 36.

The full 360° turning circle of the castor wheels 106 is represented by the dashed line 114 in FIG. 5. From this it can be seen that the length of the engaging structure 26 and the spacing of the steering wheels 8 must be such that they do not foul the castor wheels 106. It will also be seen that the steering wheels 8 must be spaced sufficiently close together that they do not foul the base frame 102 when steering the roll cage.

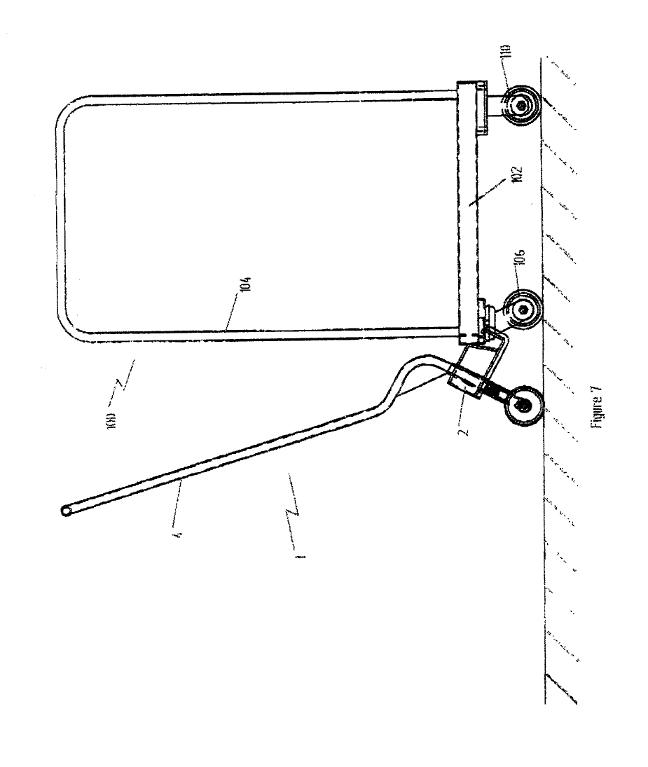

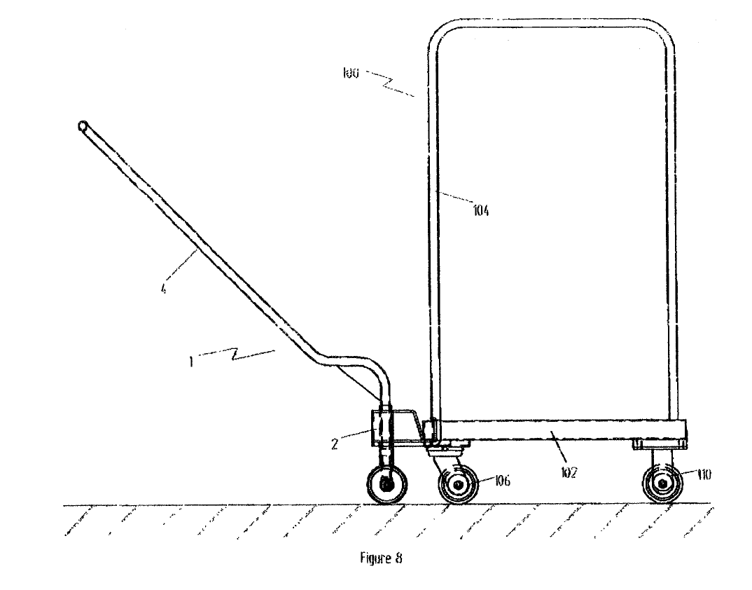

The method of engaging the device 1 with the roll cage 100 will now be explained with reference to FIGS. 6 to 8. First the steering tiller 4 is raised causing the body 2 to swivel around the axle 6 and the engaging structure 26 to lower by virtue of its cantilever mounting. The steering tiller 4 is raised until the rearward face 32 and the retention lip 34 are below level of the base frame 102 as shown in FIG. 6. The engaging structure 26 can then be passed beneath the portion of the base frame 102 which extends between the castor wheels 106 as shown in FIG. 7. The steering tiller 4 is then lowered so that the lower end of the steering tiller is brought vertical and the base frame 102 is tightly received within the channel 36 as shown in FIG. 8. As the base frame 102 is cammed into the channel 36 along the inclined forward face 28, the body 2 is forced axially down along the lower end of the steering tiller 4 against the bias of the coil spring 16. This downward movement releases the web 14 from the V-shaped recess 24 to allow the steering tiller 4 to pivot freely. Once the device 1 is securely engaged with the base frame 102 it can be used to steer and handle the roll cage 100 using the steering tiller 4.

To disengage the device 1 from the roll cage 100 the above method is simply carried out in reverse.

We claim:

1. A steering and handling device for moving a roll cage which has a generally U-shaped base frame with castor wheels at its forward end and wheels at its rearward end, the device comprising:
a body defining a steering axis and having channel means extending in cantilever rearwardly of the steering axis for releasably engaging the base frame of the roll cage between the castor wheels; and
a steering member pivotally mounted on the body and comprising
a steering tiller pivotable about the steering axis, extending forwardly and upwardly from the body and terminating in a handle portion, and
wheel means rotatably mounted on an axle mounted on the steering tiller beneath the body.

2. A device according to claim 1, further comprising a resilient member positioned between the axle and the body so as to bias the body away from the axle.

3. A device according to claim 2, wherein the resilient means is a coil spring around the steering tiller below the body, in compression between the axle and the body.

4. A device according to claim 2, further comprising releasable lock means for preventing relative pivotal movement between the steering member and the body and locking the steering tiller in the straight ahead position relative to the body.

5. A device according to claim 3, further comprising releasable lock means for preventing relative pivotal movement between the steering member and the body and locking the steering tiller in the straight ahead position relative to the body.

6. A device according to claim 4, wherein the releasable locking means comprises a fixed detent portion of the steering member which, under the bias of the resilient member, engages in a recess in the body to prevent relative pivotal movement between the steering tiller and the body but which can be released from the recess to release the locking means by compression of the resilient member.

7. A device according to claim 6, wherein on either side of the recess is a cam slope to encourage the detent portion to enter the recess under the bias of the resilient means.

8. A device according to claim 1, wherein the wheel means comprise one wheel at each end of the axle.

9. A device according to claim 1, wherein the channel means comprises an inclined forward face, a bottom face and a rearward face for surrounding three sides of the base frame of the roll cage, and a retention lip extending forwardly from the top edge of the rearward face to lap over the top of the base frame of the roll cage to engage the base frame when the steering axis of the device is in a substantially vertical orientation.
